(19) United States
(12) Patent Application Publication
(10) Pub. No.: US 2024/0388888 A1
(43) Pub. Date: Nov. 21, 2024

(54) USER EQUIPMENT REFRESH HANDLING DURING USER ACTIVITY

(71) Applicant: GOOGLE LLC, Mountain View, CA (US)

(72) Inventors: Edison Chen, Taipei (TW); Aakash Phoughat, New Taipei City (TW)

(21) Appl. No.: 18/198,977

(22) Filed: May 18, 2023

(51) Int. Cl. H04W 8/18; H04W 8/20

(52) U.S. Cl. CPC H04W 8/183; H04W 8/20

(57) ABSTRACT

A user equipment (UE) stores a refresh command for subsequent processing. In response to receiving the refresh command from a subscriber identity module (SIM), a processor of the UE determines if there is specified user activity at the UE, such as a voice call, that will be interrupted or negatively affected by processing the refresh command. If not, the processor executes the refresh command. If there is specified user activity at the UE when the refresh command is issued by the SIM, the processor stores the refresh command for subsequent processing. In response to cessation of the user activity, the processor retrieves and executes the refresh command.

### BACKGROUND

A user equipment (UE) is configured to attach to a cellular network within range. To establish a data connection between the UE and an attached cellular network, the UE includes a modem to transmit data to and receive data from the cellular network and a subscriber identity module (SIM) device that stores identification and subscriber information associated with the user equipment. The UE further includes one or more processors to execute software (e.g., an operating system and applications) that allow a user to interact with the UE. For at least some of these interactions, such as voice calls, the processor employs a copy of at least some of the information stored at the SIM.

Further, under certain conditions the information stored at the SIM is modified, such as in response to an application changing a user profile or in response to information received from a carrier over the cellular network. In response to the modification, the SIM sends a command, referred to as a refresh command, to the UE processor to indicate the change in information. However, if the user is interacting with the UE, the processor cannot immediately process the refresh command, and therefore indicates to the SIM that the processor is busy. The SIM then waits a specified period of time until retrying the refresh command. Thus, under these conditions, the processor employs outdated SIM information for some period of time, potentially leading to errors at the UE and negatively impacting the user experience.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a user equipment (UE) that stores a received refresh command for later processing in accordance with some embodiments.

FIG. 2 is a flow diagram of a method of storing a received refresh command for subsequent processing at a UE in accordance with some embodiments.

FIG. 3 is a flow diagram of a method of processing a previously stored refresh command at a UE in accordance with some embodiments.

FIG. 4 is a signal flow diagram illustrating an example method of the UE of FIG. 1 storing and subsequently processing a received refresh command in accordance with some embodiments.

### DETAILED DESCRIPTION

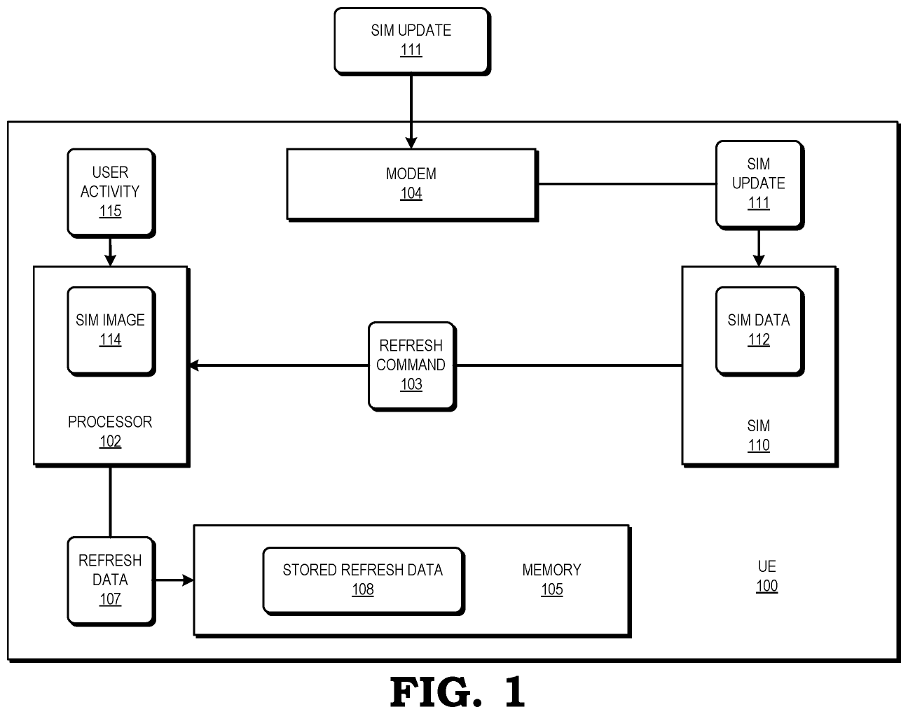

FIGS. 1-4 illustrate systems and techniques for storing a refresh command for subsequent processing at a UE in accordance. In some embodiments, in response to receiving the refresh command from a SIM, a processor of the UE determines if there is specified user activity at the UE, such as a voice call, that will be interrupted or negatively affected by processing the refresh command. If not, the processor executes the refresh command. If there is specified user activity at the UE when the refresh command is issued by the SIM, the processor stores the refresh command for subsequent processing. In response to cessation of the user activity, the processor retrieves and executes the refresh command. The UE is thereby able to more quickly process received refresh commands when there is specified user activity, thus reducing errors and improving the overall user experience.

To illustrate, in at least some cases the processor maintains a copy of SIM information for use by executing software. This copy is referred to herein as a SIM image. A mismatch between the SIM image and the information stored at the SIM can result in errors, such as when the SIM indicates a different enabled profile than is indicated by the SIM image. Accordingly, it is desirable to keep the SIM image as up-to-date as possible. To update the SIM image, the SIM issues a refresh command to the processor in response to a change in the stored SIM information. The processor executes the refresh command and thereby updates the SIM image. However, immediate processing of the refresh command can lead, under certain circumstances, to a poor user experience. For example, the refresh command typically cannot be processed during a voice call at the UE. Accordingly, immediate processing of the refresh command during a voice call would require termination of the voice call, leading to a poor user experience.

Conventionally, if the UE processor receives a refresh command during specified user activity such as a voice call, the processor indicates a busy status to the SIM and does not process the refresh command. In response to the busy status indication, a typical SIM waits for a specified period and reissues the refresh command. However, in many cases, the wait period is relatively long (e.g., five minutes or more). Further, some SIMs will not reissue a refresh command. Accordingly, at a conventional UE, there can be a relatively long period of time when the information stored at the SIM and the information stored at the SIM image are mismatched, resulting in errors at the UE. Using the techniques described herein, the UE processor stores refresh commands received during user activity, and executes the stored refresh command in response to cessation of the user activity. The UE processor thereby reduces the amount of time that the SIM information and the SIM image are mismatched, which reduces errors at the UE and improves the user experience.

FIG. 1 illustrates an example hardware configuration for a UE 100 in support of storing refresh commands for subsequent in accordance with some embodiments. For purposes of description, it is assumed that the UE 100 is any device that is capable of connecting to one or more cellular networks using a SIM. Thus, in different embodiments, the UE 100 is a smartphone, a computer (e.g., a desktop or laptop computer), a wearable device (e.g. a smartwatch), a game console, a vehicular entertainment or navigation unit, and the like.

In the depicted example, the UE 100 includes a central processing unit (CPU) or other general processor 102, a modem 104, a memory 105, and a SIM 110. In some embodiments, the UE 100 includes additional circuitry to support wireless network connections, such as a wireless local area network (WLAN) transceiver and modem, at least one WLAN antenna suitable for radio frequency (RF) signaling and signal processing in one or more frequency bands typically associated with WLAN connections, an RF transceiver, and at least one RF antenna suitable for RF signaling and signal processing in frequency bands associated with cellular radio access technologies (RATs). Further, it will be appreciated that the UE 100 can include a number of additional components omitted from FIG. 1 for ease of illustration, including, for example, one or more displays, one or more touchscreens, keypads, mice, touchpads, microphones, speakers, and other user input/output devices, one or more sensors, batteries or other power sources, graphical processing units (GPUs) or other coprocessors, and the like.

As a general operational overview, the general processor 102 executes executable instructions from a software stack that includes an operating system (OS) and one or more user software applications and which further can include the protocol stacks executed by processors of the modem 104. The OS manages the general operation of the various hardware components of the UE 100 as well as supports the execution of the one or more user software applications, with the user software applications typically accessed from system memory 105 for execution by the general processor 102. During execution, one or more processes of the OS or the user software application (referred to generally as “local processes”) may seek to wirelessly communicate data with a network connected to the UE 100.

In the event that a local process is seeking to communicate data with a network, the general processor 102 can employ a cellular RAT connection, communicating data via the modem 104. For these connections the modem 104 can handle lower-level operations associated with the corresponding network protocol, such as some or all of the physical, data link, and network layers, while the OS and the user software application executing at the general processor 102 support the higher-level layers of the network protocol, such as the transport, session, presentation, and application layers.

To support connection to the network, the UE 100 employs the SIM 110. In particular, the SIM 110 provides the data and functionality for connection to a corresponding network. In some embodiments, the UE 100 is configured to include multiple SIMs (that is, one or more SIMs in addition to SIM 110) with each SIM providing the data and functionality for connection to a corresponding network. The data stored by the SIM 110 to provide the network connection is illustrated as SIM data 112. To support execution of the OS, one or more applications, or both, the general processor 102 caches at least a portion of the SIM data 112 as SIM image 114. For example, in some embodiments the general processor 102 creates the SIM image 114 during an initialization stage (e.g., a boot stage) by copying at least a portion of the SIM data 112 and storing the copied data, as the SIM image 114, at a local memory (e.g., a cache) of the processor 102. One or more applications executing at the processor 102 use the data at the SIM image 114 to carry out designated operations. For example, in some embodiments a voice call application uses the data at the SIM image 114 to establish a voice call connection over a network via the modem 104.

In response to one or more specified events, the SIM data 112 is updated. For example, the UE 100 can receive a SIM update 111 from the network via the modem 104, wherein the SIM update indicates a modification to be made to the SIM data 112. In response to the SIM update 111, the SIM 110 makes the indicated changes to the SIM data 112. In some embodiments, an application executing at the processor 102 can request changes to the SIM data 112. For example, the SIM 110 can store SIM data associated with different profiles (e.g., different user profiles, different account profiles, and the like), and an application executing at the processor 102 can request a change in the active profile, thereby changing the SIM data 112 provided by the SIM 110.

A change in the SIM data 112 can result in a mismatch with the SIM image 114. That is, after a change in the SIM data 112, the SIM image 114 can include data that differs from the corresponding portion of the SIM data 112. Accordingly, in response to a change in the SIM data 112, the SIM 110 is configured to issue a refresh command 103, wherein the refresh command 103 indicates any changes to the SIM data 112, for which corresponding changes are to be made at the SIM image 114. In some embodiments, the refresh command 103 includes a code or other identifier for the type of refresh that is to be performed by the processor 102. That is, each code or identifier indicates a corresponding sequence of actions to be executed by the processor 102 in order to update the SIM image 114. In some embodiments, the refresh command 103 is a refresh command that is consistent with (or as set forth in) a Universal Mobile Telecommunications System (UTMS) specification, such as European Telecommunications Standards Institute (ETSI) Technical Standard (TS) 102 22 version 17.1.0 Release 17. Examples of different types of refresh commands that can be indicated by the code or other identifier of the refresh command 103 include Network Access Application (NAA) Application Reset, NAA Session Reset, File Change Notification, NAA File Change Notification, Embedded Universal Integrated Circuit Card (eUICC) Reset, eUICC Profile State Change, Application Update, and the like.

In response to receiving the refresh command 103, the processor 102 determines whether there is user activity (e.g., user activity 115) that prevents immediate execution of the refresh command 103. Examples of such user activity include a voice call, a video call, an emergency call, Short Message Service (SMS) or other text message activity, and the like. In at least some cases, processing of the refresh command 103 requires temporary disabling or modification of the modem 104, and therefore immediate processing of the refresh command 103 would interrupt these user activities, resulting in a poor user experience. Accordingly, in response to identifying user activity 115 when the refresh command 103 is received, the processor 102 stores refresh data 107 at the memory 105 (represented as stored refresh data 108 at FIG. 1). The stored refresh data 108 includes any information needed to subsequently execute the refresh command 103. Thus, in some embodiments, the stored refresh data 108 is a copy of the refresh command 103.

In response to cessation of the user activity 115, the processor 102 accesses the stored refresh data 108 and, based on the accessed information, executes the refresh command 103. Thus, the processor 102 does not wait for the SIM 110 to resend the refresh command 103, but instead executes the refresh command 103 a relatively short amount of time after cessation of the user activity 115. This ensures that the amount of time that there is a mismatch between the SIM data 112 and the SIM image 114 is relatively small, reducing the likelihood of errors resulting from the mismatch and improving the overall user experience with the UE 100.

In some cases, the SIM 110 can issue multiple different refresh commands 103 while the user activity 115 is occurring. Furthermore, these different refresh commands can have different scopes, wherein the scope of a refresh command refers to the particular data of the SIM image 114 to be modified. In some embodiments, in response to receiving a refresh command 103, the processor 102 determines the scope of the refresh command (or commands) indicated by the stored refresh data 108. In response to determining that the scope of the stored refresh data 108 does not cover the scope of the refresh command 103, the processor 102 modifies the stored refresh data 108 to cover the scope of the received refresh command 103. That is, the processor 102 ensures that the stored refresh data 108 represents the scope of all refresh commands received during the user activity 115. In response to cessation of the user activity 115, the processor 102 uses the stored refresh data 108 to execute a refresh command with the indicated scope, thus efficiently processing the multiple received refresh commands.

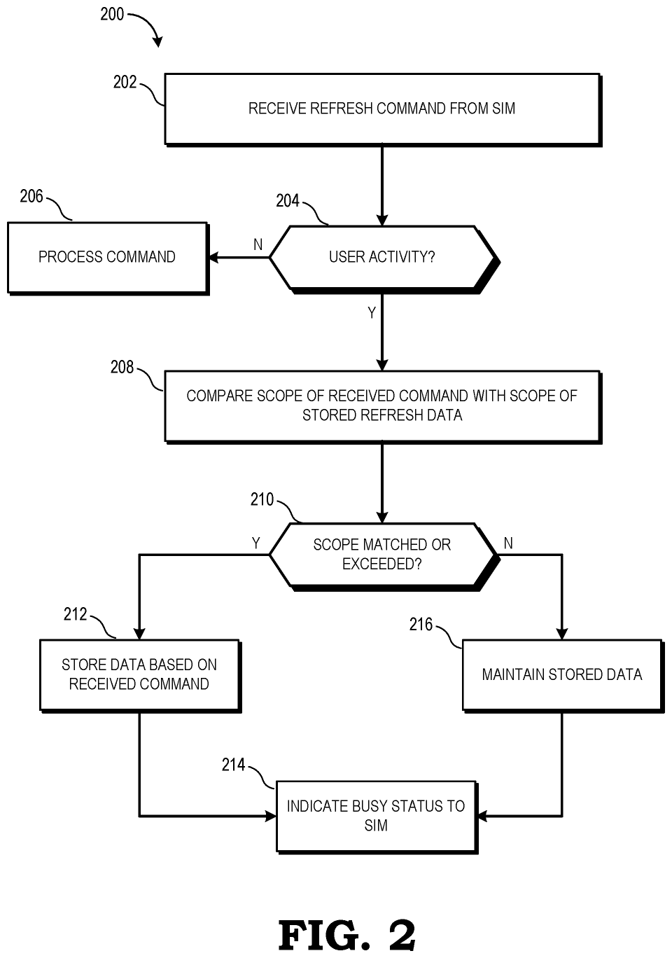

FIG. 2 illustrates a flow diagram of a method 200 of storing a refresh command for subsequent processing at a UE in accordance with some embodiments. For purposes of description, the method 200 is described with respect to an example embodiment at the UE 100 of FIG. 1.

At block 202, the processor 102 receives a refresh command 103 from the SIM 110, indicating the SIM image 114 is to be modified based on a change in the SIM data 112. In response, at block 204, the processor 102 determines if there is user activity 115 that prevents immediate processing of the refresh command 103. If not, the method flow moves to block 206 and the processor 102 immediately executes the refresh command 103, and in particular modifies the SIM image 114 as indicated by the refresh command 103.

Returning to block 204, in response to identifying user activity 115 the method flow moves to block 208 and the processor 102 compares the scope of the received refresh command 103 with the scope of the stored refresh data 108. At block 210 the processor 102 determines, based on the comparison, if the scope of the refresh command 103 matches or exceeds the scope indicated by the stored refresh data 108. If so, the method flow moves to block 212 and the processor 102 modifies the stored refresh data 108 to reflect the scope of the refresh command 103. The method flow proceeds to block 214 and the processor 102 indicates a busy status to the SIM 110.

Returning to block 210, if the processor 102 determines that the scope of the stored refresh data 108 exceeds the scope of the refresh command 103, the method flow proceeds to block 216 and the processor 102 maintains the stored refresh data 108. That is, because the scope of the received refresh command 103 is already covered by the scope of the stored refresh data 108, the processor 102 does not modify the stored refresh data 108. The method flow proceeds to block 214 and the processor 102 indicates a busy status to the SIM 110.

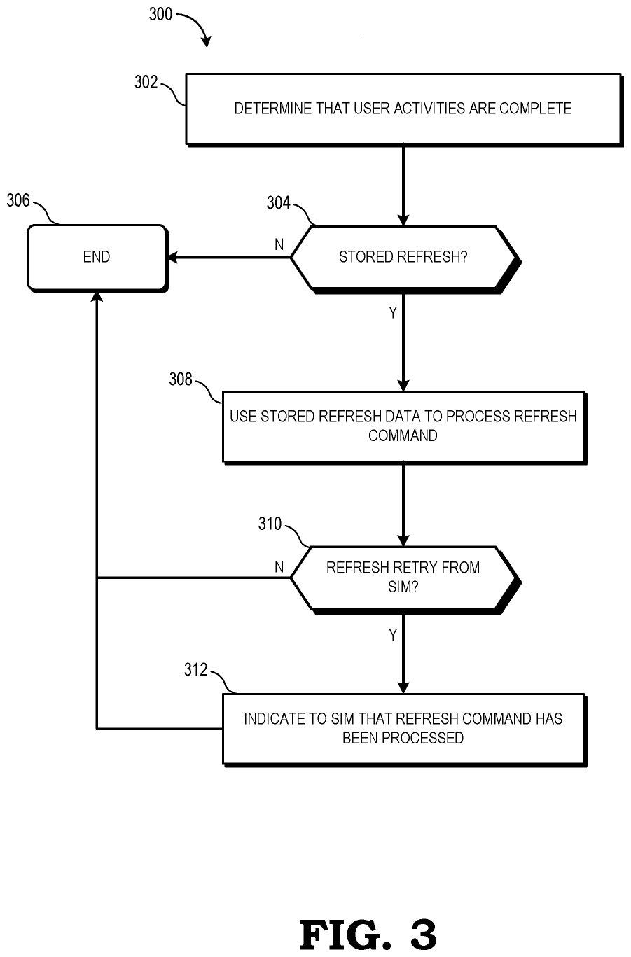

FIG. 3 illustrates a flow diagram of a method 300 of processing a previously stored refresh command at a UE in accordance with some embodiments. For purposes of description, the method 300 is described with respect to an example embodiment at the UE 100 of FIG. 1.

At block 302, the processor 102 determines that the user activity 115 has completed. In response, at block 304 the processor 102 accesses the memory 105 to determine if there is stored refresh data 108, indicating that the refresh command 103 was received during the user activity 115. If not, the method flow moves to block 306 and the method 300 ends.

Returning to block 304, if the processor 102 determines that the stored refresh data is stored at the memory 105, the method flow moves to block 308 and the processor 102 uses the stored refresh data 108 to process the refresh command 103. For example, in some embodiments, the processor 102 uses the stored refresh data to identify portions of the SIM image 114 that are to be updated. The processor 102 then requests those updated portions from the SIM 110, and updates the SIM image 114 accordingly, so that the SIM image 114 matches the SIM data 112.

The method flow proceeds to block 310, and the processor 102 determines if the SIM 110 has attempted to reissue (that is, to retry) the refresh command 103. If not, the method flow moves to block 306 and the method 300 ends. If the SIM 110 has attempted to retry the refresh command 103, the method flow moves to block 312 and the processor 102 indicates to the SIM 110 that the refresh command 103 has been processed. The processor 102 thereby prevents the SIM 110 from continuing to reissue the refresh command 103. The method flow moves to block 306 and the method 300 ends.

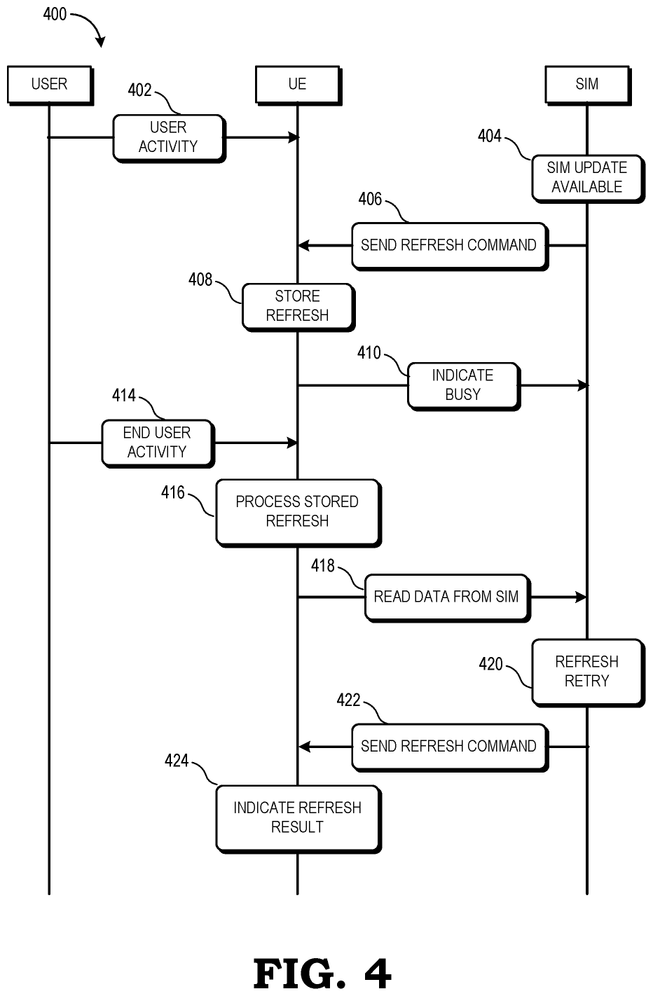

FIG. 4 illustrates a signal flow diagram 400 of a method of the UE 100 storing and subsequently processing a received refresh command in accordance with some embodiments. At block 402, a user initiates user activity (e.g., user activity 115) at the processor 102, such as by initiating a voice call, starting a text messaging application, and the like. At block 404, the SIM 110 determines that there is a SIM update available. That is, the SIM 110 determines that changes have been made to the SIM data 112 (e.g., in response to data received from a network carrier) and that these changes have not yet been made to the SIM image 114 at the processor 102. Accordingly, at block 406 the SIM 110 sends the refresh command 103 to the processor 102.

In response to the refresh command 103, the processor 102 determines that the user activity 115 is ongoing, and is of a type that is not to be interrupted by processing of the refresh command 103. Accordingly, at block 408 the processor 102 stores refresh data 107, representing the refresh command 103, at the memory 105. At block 410, the processor 102 also indicates a busy status to the SIM 110, thus indicating that the refresh command 107 has not been processed, and therefore that the SIM image 114 has not been updated.

At block 414, the user ends the user activity 115, such as by terminating a voice call or closing an application. In response, at block 416 the processor 102 retrieves the stored refresh data 108, and uses the retrieved data to process the refresh command 103. In particular, at block 418 the processor 102 reads at least a portion of the SIM data 112 from the SIM 110, and uses the read data to update the SIM image 114.

At block 420, the SIM 110 determines that a retry of the refresh command 103 is needed, based on the busy status indicated by the processor 102 at block 410. Accordingly, at block 422, the SIM 110 again sends the refresh command 103. Because the processor 102 has already processed the refresh command 103, at block 424 the processor 102 sends a refresh command result to the SIM 110, such as an indication that processing of the refresh command 103 is complete.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design shown herein, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a processor of a user equipment (UE), a first refresh command from a subscriber identity module (SIM); and
storing first data representing the first refresh command in response to identifying user activity at the UE when the first refresh command is received.

2. The method of claim 1, further comprising:
using the stored first data to process the first refresh command in response to identifying cessation of the user activity at the UE.

3. The method of claim 2, further comprising:
in response to using the stored first data to process the first refresh command, sending a response associated with processing the first refresh command to the SIM.

4. The method of claim 3, wherein sending the refresh command response comprises:
sending the response based on an attempt to retry the refresh command by the SIM.

5. The method of claim 1, further comprising:
receiving, at the processor of the UE, a second refresh command from the SIM; and
in response to identifying user activity at the UE when the second refresh command is received, comparing second data representing the second refresh command to the stored first data.

6. The method of claim 5, further comprising:
updating the stored first data in response to determining a scope of the second refresh command exceeds a scope of the first refresh command.

7. The method of claim 6, further comprising:
maintaining the stored first data in response to determining the scope of the first refresh command matches the scope of the second refresh command.

8. The method of claim 7, further comprising:
maintaining the stored first data in response to determining the scope of the first refresh command exceeds the scope of the second refresh command.

9. The method of claim 1, wherein the first refresh command comprises at least one of: a file change notification for the SIM; or an application update command.

10. A user equipment configured to perform the method of claim 1.
